(19) United States
(12) Patent Application Publication
(10) Pub. No.: US 2024/0247003 A1
(43) Pub. Date: Jul. 25, 2024

(54) YTTRIUM COMPLEXES AND RELATED METHODS

(71) Applicant: ENTEGRIS, INC., Billerica, MA (US)

(72) Inventors: Vagulejan Balasanthiran, Pennsburg, PA (US); Scott A. Laneman, Vernon Hills, IL (US)

(21) Appl. No.: 18/412,302

(22) Filed: Jan. 12, 2024

Related U.S. Application Data
(60) Provisional application No. 63/438,741, filed on Jan. 12, 2023.

(51) Int. Cl. C07F 5/00

(52) U.S. Cl. CPC C07F 5/00

(57) ABSTRACT

Yttrium complexes and related methods are provided. A method for preparing a yttrium complex comprises contacting a metal alkylcyclopentadienyl compound and a yttrium trihalide compound in a non-coordinating solvent, so as to obtain a tris(alkylcyclopentadienyl)yttrium complex. A composition comprises a tris(alkylcyclopentadienyl)yttrium complex.

### FIELD

The present disclosure relates to yttrium complexes and related methods.

### BACKGROUND

Conventional synthesis of yttrium complexes involves multiple steps. The multiple steps cause a reduction in yield and a reduction in purity of yttrium complexes.

### SUMMARY

Some embodiments relate to a composition. In some embodiments, the composition comprises a complex of the formula:

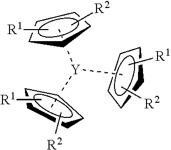

where:
R¹ and R² are each independently a hydrogen or an alkyl;
wherein the complex has a purity of at least 70% as determined by ¹H NMR;
wherein the complex is a non-sublimated product.

Some embodiments relate to a method for forming a complex. In some embodiments, the method comprises contacting a metal alkylcyclopentadienyl compound and a yttrium trihalide compound in a non-coordinating solvent, so as to obtain a tris(alkylcyclopentadienyl)yttrium complex. In some embodiments, the method comprises removing at least a portion of the non-coordinating solvent to obtain the tris(alkylcyclopentadienyl)yttrium complex in a solid phase. In some embodiments, the method comprises recrystallizing the tris(alkylcyclopentadienyl)yttrium complex.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a flowchart of a method for preparing a yttrium complex, according to some embodiments.

### DETAILED DESCRIPTION

Among those benefits and improvements that have been disclosed, other objects and advantages of this disclosure will become apparent from the following description taken in conjunction with the accompanying FIGURES. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “alkyl” refers to a hydrocarbon compound having from 1 to 30 carbon atoms. An alkyl having n carbon atoms may be designated as a “C alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises at least one of a C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₅-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises at least one of a C₁ alkyl, a C₂ alkyl, a C₃ alkyl, a C₄ alkyl, a C₅ alkyl, a C₆ alkyl, a C₇ alkyl, a C₈ alkyl, a C₉ alkyl, a C₁₀ alkyl, or any combination thereof. In some embodiments, the alkyl comprises at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the alkyl does not comprise a C₂ alkyl (e.g., ethyl).

As used herein, the term “halide” refers to a —Cl, —Br, —I, or —F.

As used herein, the term “non-sublimated product” refers to a product which is not a result of a process in which a substance undergoes a direct transition from a solid phase to a gas phase. In some embodiments, the non-sublimated product is a product having the properties of a non-sublimated complex.

Conventional synthesis of yttrium complexes, such as, tris(alkylcyclopentadienyl)yttrium(III) complexes, requires multiple steps to purify the product. For example, conventional synthetic routes employ tetrahydrofuran. The tetrahydrofuran coordinates to yttrium complexes and must be removed by a series of extraction steps and sublimation steps. The extraction steps and sublimation steps have at least the disadvantage of reducing yield of the reaction and requiring a more complex method of synthesis.

Embodiments are provided herein that overcome the challenges and disadvantages of conventional synthesis and of yttrium complexes prepared according to conventional synthesis, among other things. Some embodiments provide a method for synthesizing a yttrium complex by contacting a metal alkylcyclopentadienyl compound and a yttrium trihalide compound in a non-coordinating solvent to obtain a tris(alkylcyclopentadienyl)yttrium complex. In some embodiments, the methods disclosed herein do not involve use of tetrahydrofuran. In some embodiments, the methods disclosed herein can achieve high yields and high purity, without any extraction steps and/or sublimation steps to purify the resulting complex. As such, in some embodiments, the methods disclosed herein provide a simple single-step synthetic route for producing yttrium complexes.

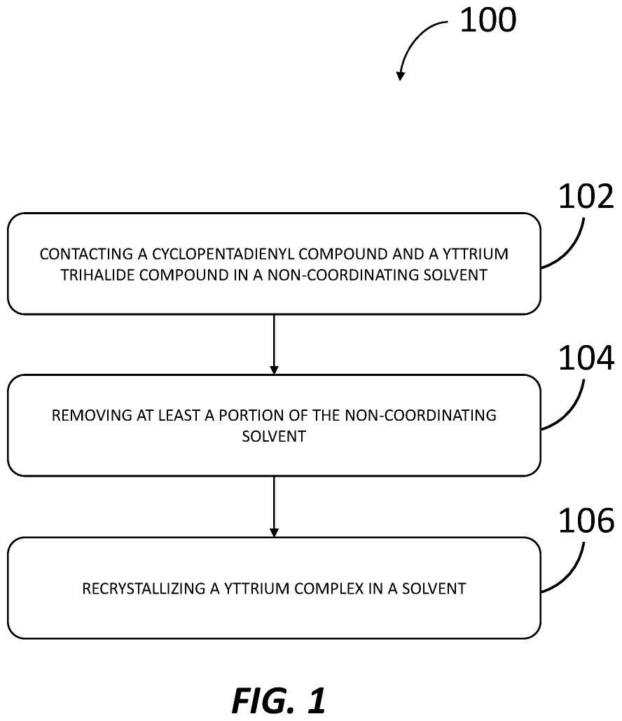

FIG. 1 is a flowchart of a method 100 for preparing a yttrium complex, according to some embodiments.

At step 102, in some embodiments, the method 100 comprises contacting a cyclopentadienyl compound and a yttrium trihalide compound in a non-coordinating solvent, so as to obtain a yttrium complex.

In some embodiments, the contacting comprises bringing at least one of the cyclopentadienyl compound, the yttrium trihalide compound, the non-coordinating solvent, or any combination thereof, into direct contact, or immediate or close proximity. In some embodiments, the contacting comprises adding the cyclopentadienyl compound, the yttrium trihalide compound, and the non-coordinating solvent to a reaction vessel (e.g., a vessel, a flask, a vial, etc.), in any order. In some embodiments, the contacting comprises combining the cyclopentadienyl compound, the yttrium trihalide compound, and the non-coordinating solvent in a reaction vessel, in any order. In some embodiments, the contacting comprises loading a reaction vessel with the cyclopentadienyl compound, the yttrium trihalide compound, and the non-coordinating solvent, in any order. In some embodiments, the contacting comprises stirring the cyclopentadienyl compound, the yttrium trihalide compound, and the non-coordinating solvent. In some embodiments, the contacting comprises mixing the cyclopentadienyl compound, the yttrium trihalide compound, and the non-coordinating solvent. In some embodiments, the contacting comprises reacting the cyclopentadienyl compound, the yttrium trihalide compound, and the non-coordinating solvent.

In some embodiments, the contacting proceeds at or to a temperature in a range of 20° C. to 150° C., or any range or subrange therebetween. In some embodiments, the contacting proceeds at or to a temperature of 20° C. to 140° C., 20° C. to 130° C., 20° C. to 120° C., 20° C. to 110° C., 20° C. to 100° C., 20° C. to 90° C., 20° C. to 80° C., 20° C. to 70° C., 20° C. to 60° C., 20° C. to 50° C., 20° C. to 40° C., 20° C. to 30° C., 30° C. to 150° C., 40° C. to 150° C., 50° C. to 150° C., 60° C. to 150° C., 70° C. to 150° C., 80° C. to 150° C., 90° C. to 150° C., 100° C. to 150° C., 110° C. to 150° C., 120° C. to 150° C., 130° C. to 150° C., or 140° C. to 150° C. In some embodiments, the contacting proceeds at or to a temperature, wherein the temperature is at or above a boiling point of the non-coordinating solvent.

In some embodiments, the cyclopentadienyl compound comprises a metal alkylcyclopentadienyl compound. In some embodiments, the metal alkylcyclopentadienyl compound is a compound or a salt of the formula:

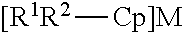

where:
Cp is a cyclopentadienyl;
R¹ and R² are each independently a hydrogen or an alkyl;
M is Na, Li, or K.

In some embodiments, R¹ and R² are the same. In some embodiments, the R¹ and R² are different.

In some embodiments, R¹ is an alkyl and R² is a hydrogen. In some embodiments, R¹ and R² are each independently an alkyl.

In some embodiments, the yttrium trihalide compound comprises at least one of YCl₃, YI₃, YBr₃, YF₃, or any combination thereof.

In some embodiments, the non-coordinating solvent comprises a solvent which does not coordinate to any compound or complex. In some embodiments, the non-coordinating solvent comprises at least one of toluene, benzene, hexane, heptane, xylene, or any combination thereof. In some embodiments, the non-coordinating solvent does not comprise tetrahydrofuran.

In some embodiments, the yttrium complex comprises a tris(alkylcyclopentadienyl)yttrium(III) complex. In some embodiments, the yttrium complex is a complex of the formula:

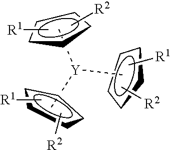

where:
R¹ and R² are each independently a hydrogen or an alkyl.

In some embodiments, R¹ and R² are the same. In some embodiments, the R¹ and R² are different.

In some embodiments, R¹ is an alkyl and R² is a hydrogen. In some embodiments, R¹ and R² are each independently an alkyl.

In some embodiments, a molar ratio of the yttrium trichloride to the cyclopentadienyl compound is 1:3 to 1:9, or any range or subrange therebetween. For example, in some embodiments, the molar ratio of the yttrium trichloride to the cyclopentadienyl compound is 1:3 to 1:8, 1:3 to 1:7, 1:3 to 1:6, 1:3 to 1:5, 1:3 to 1:4, 1:4 to 1:9, 1:5 to 1:9, 1:6 to 1:9, 1:7 to 1:9, or 1:8 to 1:9.

In some embodiments, the yttrium complex is not coordinated to tetrahydrofuran.

In some embodiments, the yield of the yttrium complex is 50% to 75%, or any range or subrange therebetween. In some embodiments, the yield of the yttrium complex is 55% to 75%, 60% to 75%, 65% to 75%, 70% to 75%, 50% to 70%, 50% to 65%, 50% to 60%, or 50% to 55%.

At step 104, in some embodiments, the method 100 comprises removing at least a portion of the non-coordinating solvent, so as to obtain a solid yttrium complex (e.g., a yttrium complex in a solid phase).

In some embodiments, the removing comprises a technique for separating the non-coordinating solvent from the yttrium complex. For example, in some embodiments, a cannula is employed for the removing. In some embodiments, the removing comprises decanting the non-coordinating solvent to obtain the yttrium complex. In some embodiments, the removing comprises pipetting the non-coordinating solvent to obtain the yttrium complex. In some embodiments, the removing comprises pouring the non-coordinating solvent out to obtain the yttrium complex. In some embodiments, the removing comprises transferring the non-coordinating solvent to another reaction vessel to obtain the yttrium complex. In some embodiments, the removing comprises evaporating the non-coordinating solvent to obtain the yttrium complex.

At step 106, in some embodiments, the method 100 comprises recrystallizing the yttrium complex.

In some embodiments, the recrystallizing comprises contacting the yttrium complex with a solvent. In some embodiments, the recrystallizing comprises dissolving the yttrium complex in a solvent. In some embodiments, the recrystallizing comprises solubilizing the yttrium complex in a solvent. In some embodiments, the recrystallizing comprises heating the yttrium complex in a solvent and subsequently allowing the yttrium complex and the solvent to cool. In some embodiments, the recrystallizing comprises combining the yttrium complex and a solvent. In some embodiments, the recrystallizing comprises adding the yttrium complex and a solvent. In some embodiments, the recrystallizing comprises stirring the yttrium complex and a solvent. In some embodiments, the recrystallizing comprises mixing the yttrium complex and a solvent. In some embodiments, the solvent comprises at least one of the non-coordinating solvents disclosed herein.

In some embodiments, the method 100 does not comprise any sublimation step. In some embodiments, the method 100 does not comprise any step comprising tetrahydrofuran.

Some embodiments relate to a composition. In some embodiments, the composition comprises or consists of a yttrium complex. In some embodiments, the yttrium complex is a complex formed according to the methods disclosed herein. In some embodiments, the composition comprises a yttrium complex of the formula:

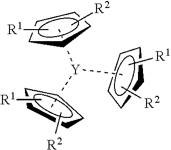

where:
R¹ and R² are each independently a hydrogen or an alkyl.

In some embodiments, R¹ and R² are the same. In some embodiments, the R¹ and R² are different.

In some embodiments, R¹ is an alkyl and R² is a hydrogen. In some embodiments, R¹ and R² are each independently an alkyl.

In some embodiments, the yttrium complex is not coordinated to tetrahydrofuran.

In some embodiments, a purity of the yttrium complex is at least 70%, at least 75%, at least 80%, at least 85%, at least 90%, at least 95%, at least 96%, at least 97%, or at least 98%. In some embodiments, the purity of the yttrium complex is 70% to 99%, 75% to 99%, 80% to 99%, 85% to 99%, 90% to 99%, 95% to 99%, 96% to 99%, 97% to 99%, or 98% to 99%. In some embodiments, the purity of the yttrium complex is 99% or greater. In some embodiments, the purity of the yttrium complex is determined by ¹H NMR.

In some embodiments, the yttrium complex is a solid. In some embodiments, the composition does not comprise a bis(alkylcyclopentadienyl)yttrium(III) complex. In some embodiments, the composition does not comprise at least one of the following impurities: (RCp)₃Y-THF; (RCp)₂YCl; (RCp)YCl₂; or any combination thereof; where R is R¹ or R²; and Cp is cyclopentadienyl.

### Comparative Example 1

### Synthesis of Tris(methylcyclopentadienyl)yttrium(III) Complex

A tris(methylcyclopentadienyl)yttrium(III) complex was synthesized from sodium methylcyclopentadiene (MeCpNa) and yttrium(III) chloride in tetrahydrofuran (THF) as a comparative example. The synthesis involved charging a 250 mL Schlenk flask with MeCpNa and YCl₃ (2 g) at room temperature under nitrogen, followed by addition of THF, with stirring. The molar ratio of YCl₃ to MeCpNa was 1:4. The resulting mixture was heated to 55° C. for 6 hrs and then allowed to settle overnight. The mother liquor was transferred to another Schlenk flask by cannula. All volatiles were removed under vacuum so as to produce a yellow product of (MeCp)₃Y with 56% yield and 90% purity as determined by ¹H-NMR.

### Example 2

### Synthesis of Tris(methylcyclopentadienyl)yttrium(III) Complex

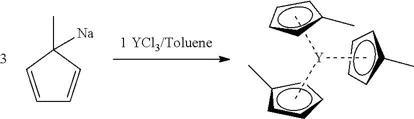

A tris(methylcyclopentadienyl)yttrium(III) complex was synthesized from sodium methylcyclopentadiene (MeCpNa) and yttrium(III) chloride in toluene. The synthesis involved charging a 250 mL Schlenk flask with MeCpNa and YCl₃ (2 g) at room temperature under nitrogen, followed by addition of toluene, with stirring. The molar ratio of YCl₃ to MeCpNa was 1:3. The resulting mixture was heated to 55° C. for 6 hrs and then allowed to settle overnight. The mother liquor was transferred to another Schlenk flask by cannula. All volatiles were removed under vacuum so as to produce a yellow product of (MeCp)₃Y with 64% yield and greater than 96% purity as determined by ¹H-NMR. Recrystallization in hexanes of (MeCp)₃Y achieved a purity of greater than 98% as determined by ¹H-NMR.

¹H NMR (C₆D₆): 5.93 ppm (m, 6H, Cp-H), 5.84 ppm (m, 6H, Cp-H), 1.91 ppm (s, 9H, Cp-CH₃).

¹³C NMR (C₆D₆): 121.74, 116.39, 111.98, 14.73.

### Example 3

### Synthesis of Tris(methylcyclopentadienyl)yttrium(III) Complex

A tris(methylcyclopentadienyl)yttrium(III) complex was synthesized from sodium methylcyclopentadiene (MeCpNa) and yttrium(III) chloride in toluene. The synthesis involved charging a 250 mL Schlenk flask with MeCpNa and YCl₃ (2 g) at room temperature under nitrogen, followed by addition of toluene, with stirring. The molar ratio of YCl₃ to MeCpNa was 1:4. The resulting mixture was heated to 55° C. for 6 hrs and then allowed to settle overnight. The mother liquor was transferred to another Schlenk flask by cannula. All volatiles were removed under vacuum so as to produce a yellow product of (MeCp)₃Y with 54% yield and greater than 95% purity as determined by ¹H-NMR. Recrystallization in hexanes of (MeCp)₃Y achieved a purity of greater than 98% as determined by ¹H-NMR.

### Example 4

### Synthesis of Tris(methylcyclopentadienyl)yttrium(III) Complex

A tris(methylcyclopentadienyl)yttrium(III) complex was synthesized from sodium methylcyclopentadiene (MeCpNa) and yttrium(III) chloride in toluene. The synthesis involved charging a 250 mL Schlenk flask with MeCpNa and YCl₃ (5 g) at room temperature under nitrogen, followed by addition of toluene, with stirring. The molar ratio of YCl₃ to MeCpNa was 1:4. The resulting mixture was heated to 55° C. for 6 hrs and then allowed to settle overnight. The mother liquor was transferred to another Schlenk flask by cannula. All volatiles were removed under vacuum so as to produce a yellow product of (MeCp)₃Y with 65% yield and greater than 95% purity as determined by ¹H-NMR. Recrystallization in hexanes of (MeCp)₃Y achieved a purity of greater than 98% as determined by ¹H-NMR.

### Example 5

### Synthesis of Tris(methylcyclopentadienyl)yttrium(III) Complex

A tris(methylcyclopentadienyl)yttrium(III) complex was synthesized from sodium methylcyclopentadiene (MeCpNa) and yttrium(III) chloride in toluene. The synthesis involved charging a 250 mL Schlenk flask with MeCpNa and YCl₃ (10 g) at room temperature under nitrogen, followed by addition of toluene, with stirring. The molar ratio of YCl₃ to MeCpNa was 1:4. The resulting mixture was heated to 55° C. for 6 hrs and then allowed to settle overnight. The mother liquor was transferred to another Schlenk flask by cannula. All volatiles were removed under vacuum so as to produce a yellow product of (MeCp)₃Y with 61% yield and greater than 96% purity as determined by ¹H-NMR. Recrystallization in hexanes of (MeCp)₃Y achieved a purity of greater than 98% as determined by ¹H-NMR.

TABLE 1
Results of Synthesis of (MeCp)₃Y of Examples 1 to 5

| | | Molar Ratio | YCl₃ | Temp | % | % |
|---|---|---|---|---|---|---|
| Example | Solvent | (MeCpNa:YCl₃) | (g) | (° C.) | Yield | Purity |
| 1 | THF | 4 | 2 | 55 | 56 | >90 |
| 2 | Toluene | 3 | 2 | 55 | 64 | 96 |
| 3 | Toluene | 4 | 2 | 55 | 54 | 95 |
| 4 | Toluene | 4 | 5 | 55 | 65 | 95 |
| 5 | Toluene | 4 | 10 | 55 | 61 | 96 |

### Example 6

### Synthesis of Tris(isopropyl-methyl-cyclopentadienyl)yttrium(III) Complex

A tris(dialkylcyclopentadienyl)yttrium(III) complex is synthesized from sodium 3-isopropyl-1-methyl-1,3-cyclopentadiene (iPrMeCpNa) and yttrium(III) chloride in toluene. The synthesis involves charging a 250 mL Schlenk flask with iPrMeCpNa and YCl₃ (10 g) at room temperature under nitrogen, followed by addition of toluene, with stirring. The molar ratio of YCl₃ to iPrMeCpNa is 1:4. The resulting mixture is heated to 55° C. for 6 hrs and then is allowed to settle overnight. The mother liquor is transferred to another Schlenk flask by cannula. All volatiles are removed under vacuum so as to produce a yellow product of (iPrMeCp)₃Y with greater than 50% yield and greater than 90% purity as determined by ¹H-NMR. Recrystallization in hexanes of (iPrMeCp)₃Y achieves a purity of greater than 98% as determined by ¹H-NMR.

### Example 7

### Synthesis of Tris(butylcyclopentadienyl)yttrium(III) Complex

A tris(butylcyclopentadienyl)yttrium(III) complex is synthesized from sodium sec-butyl-cyclopentadiene (sec-butyl-CpNa) and yttrium(III) chloride in toluene. The synthesis involves charging a 250 mL Schlenk flask with sec-butyl-CpNa and YCl₃ (10 g) at room temperature under nitrogen, followed by addition of toluene, with stirring. The molar ratio of YCl₃ to sec-butyl-CpNa is 1:4. The resulting mixture is heated to 55° C. for 6 hrs and then is allowed to settle overnight. The mother liquor is transferred to another Schlenk flask by cannula. All volatiles are removed under vacuum so as to produce a yellow product of (sec-butyl-Cp)₃Y with greater than 50% yield and greater than 90% purity as determined by ¹H-NMR. Recrystallization in hexanes of (sec-butyl-Cp)₃Y achieves a purity of greater than 98% as determined by ¹H-NMR.

### Aspects

Various Aspects are described below. It is to be understood that any one or more of the features recited in the following Aspect(s) can be combined with any one or more other Aspect(s).

Aspect 1. A composition comprising:
a complex of the formula:

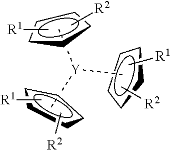

where:
   R¹ and R² are each independently a hydrogen or an alkyl;
   wherein the complex has a purity of at least 70% as determined by ¹H NMR;
   wherein the complex is a non-sublimated product.

Aspect 2. The composition according to Aspect 1, wherein R¹ is an alkyl and R² is a hydrogen.

Aspect 3. The composition according to any one of Aspects 1-2, wherein the alkyl is a linear alkyl.

Aspect 4. The composition according to any one of Aspects 1-3, wherein the alkyl is a branched alkyl.

Aspect 5. The composition according to any one of Aspects 1-4, wherein R¹ and R² are each independently an alkyl.

Aspect 6. The composition according to any one of Aspects 1-5, wherein the alkyl is C₁ alkyl, a C₃ alkyl, or a C₄ alkyl.

Aspect 7. The composition according to any one of Aspects 1-6, wherein the alkyl is methyl.

Aspect 8. The composition according to any one of Aspects 1-7, wherein the alkyl is n-propyl or isopropyl.

Aspect 9. The composition according to any one of Aspects 1-8, wherein the alkyl is n-butyl, sec-butyl, tert-butyl, or isobutyl.

Aspect 10. The composition according to any one of Aspects 1-9, wherein the alkyl is methyl, n-propyl, isopropyl, n-butyl, sec-butyl, tert-butyl, or isobutyl.

Aspect 11. The composition according to any one of Aspects 1-10, wherein the complex has a purity of at least 95%.

Aspect 12. The composition according to any one of Aspects 1-11, wherein the complex has a purity of 95% to 99%.

Aspect 13. The composition according to any one of Aspects 1-12, wherein the complex is not coordinated to tetrahydrofuran.

Aspect 14. A method for forming a compound, the method comprising:
contacting a metal alkylcyclopentadienyl compound and a yttrium trihalide compound in a non-coordinating solvent to obtain a tris(alkylcyclopentadienyl)yttrium complex.

Aspect 15. The method according to Aspect 14, wherein the metal alkylcyclopentadienyl compound comprises a compound of the formula:

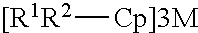

where:
   Cp is a cyclopentadienyl;
   R¹ and R² are each independently a hydrogen or an alkyl;
   M is Na, Li, or K.

Aspect 16. The method according to any one of Aspects 14-15, wherein R¹ is an alkyl and R² is a hydrogen.

Aspect 17. The method according to any one of Aspects 14-15, wherein the alkyl is a linear alkyl.

Aspect 18. The method according to any one of Aspects 14-15, wherein the alkyl is a branched alkyl.

Aspect 19. The method according to any one of Aspects 14-15, wherein R¹ and R² are each independently an alkyl.

Aspect 20. The method according to any one of Aspects 14-15, wherein the alkyl is C₁ alkyl, a C₃ alkyl, or a C₄ alkyl.

Aspect 21. The method according to any one of Aspects 14-15, wherein the alkyl is methyl.

Aspect 22. The method according to any one of Aspects 14-15, wherein the alkyl is n-propyl or isopropyl.

Aspect 23. The method according to any one of Aspects 14-15, wherein the alkyl is n-butyl, sec-butyl, tert-butyl, or isobutyl.

Aspect 24. The method according to any one of Aspects 14-15, wherein the alkyl is methyl, n-propyl, isopropyl, n-butyl, sec-butyl, tert-butyl, or isobutyl.

Aspect 25. The method according to any one of Aspects 14-24, wherein the yttrium trihalide compound comprises at least one of YCl₃, YI₃, YBr₃, YF₃, or any combination thereof.

Aspect 26. The method according to any one of Aspects 14-25, wherein the non-coordinating solvent comprises at least one of toluene, benzene, hexane, heptane, xylene, or any combination thereof.

Aspect 27. The method according to any one of Aspects 14-26, wherein the contacting proceeds at a temperature of 20° C. to 150° C.

Aspect 28. The method according to any one of Aspects 14-27, wherein the non-coordinating solvent does not comprise tetrahydrofuran.

Aspect 29. The method according to any one of Aspects 14-28, wherein the method does not comprise any sublimation step.

Aspect 30. The method according to any one of Aspects 14-29, wherein the tris(alkylcyclopentadienyl)yttrium complex is a complex of the formula:

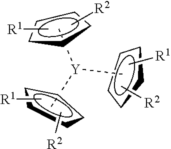

where:
   R¹ and R² are each independently a hydrogen or an alkyl.

Aspect 31. The method according to any one of Aspects 14-30, wherein R¹ is an alkyl and R² is a hydrogen.

Aspect 32. The method according to any one of Aspects 14-30, wherein the alkyl is a linear alkyl.

Aspect 33. The method according to any one of Aspects 14-30, wherein the alkyl is a branched alkyl.

Aspect 34. The method according to any one of Aspects 14-30, wherein R¹ and R² are each independently an alkyl.

Aspect 35. The method according to any one of Aspects 14-30, wherein the alkyl is C₁ alkyl, a C₃ alkyl, or a C₄ alkyl.

Aspect 36. The method according to any one of Aspects 14-30, wherein the alkyl is methyl.

Aspect 37. The method according to any one of Aspects 14-30, wherein the alkyl is n-propyl or isopropyl.

Aspect 38. The method according to any one of Aspects 14-30, wherein the alkyl is n-butyl, sec-butyl, tert-butyl, or isobutyl.

Aspect 39. The method according to any one of Aspects 14-30, wherein the alkyl is methyl, n-propyl, isopropyl, n-butyl, sec-butyl, tert-butyl, or isobutyl.

Aspect 40. The method according to any one of Aspects 14-30, wherein the complex has a purity of at least 95%.

Aspect 41. The method according to any one of Aspects 14-30, wherein the complex has a purity of 95% to 99%.

Aspect 42. The method according to any one of Aspects 14-41, further comprising:
removing at least a portion of the non-coordinating solvent to obtain the tris(alkylcyclopentadienyl)yttrium complex in a solid phase.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A composition comprising:
a complex of the formula: 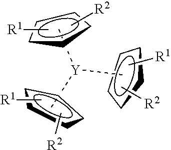
where:
R¹ and R² are each independently a hydrogen or an alkyl;
wherein the complex has a purity of at least 70% as determined by ¹H NMR;
wherein the complex is a non-sublimated product.

2. The composition of claim 1, wherein R¹ is an alkyl and R² is a hydrogen.

3. The composition of claim 1, wherein R¹ and R² are each independently an alkyl.

4. The composition of claim 1, wherein the alkyl is C₁ alkyl, a C₃ alkyl, or a C₄ alkyl.

5. The composition of claim 1, wherein the alkyl is methyl.

6. The composition of claim 1, wherein the alkyl is n-propyl or isopropyl.

7. The composition of claim 1, wherein the alkyl is n-butyl, sec-butyl, tert-butyl, or isobutyl.

8. The composition of claim 1, wherein the complex has a purity of 95% to 99%.

9. The composition of claim 1, wherein the complex is not coordinated to tetrahydrofuran.

10. A method for forming a compound, the method comprising:
contacting a metal alkylcyclopentadienyl compound and a yttrium trihalide compound in a non-coordinating solvent to obtain a tris(alkylcyclopentadienyl)yttrium complex.

11. The method of claim 10, wherein the metal alkylcyclopentadienyl compound comprises a compound of the formula: 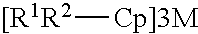
where:
Cp is a cyclopentadienyl;
R¹ and R² are each independently a hydrogen or an alkyl;
M is Na, Li, or K.

12. The method of claim 11, wherein R¹ is an alkyl and R² is a hydrogen.

13. The method of claim 11, wherein R¹ and R² are each independently an alkyl.

14. The method of claim 11, wherein the alkyl is C₁ alkyl, a C₃ alkyl, or a C₄ alkyl.

15. The method of claim 11, wherein the alkyl is methyl, n-propyl, isopropyl, n-butyl, sec-butyl, tert-butyl, or isobutyl.

16. The method of claim 11, wherein the yttrium trihalide compound comprises at least one of YCl₃, YI₃, YBr₃, YF₃, or any combination thereof.

17. The method of claim 11, wherein the non-coordinating solvent comprises at least one of toluene, benzene, hexane, heptane, xylene, or any combination thereof.

18. The method of claim 11, wherein the contacting proceeds at a temperature of 20° C. to 150° C.

19. The method of claim 11, wherein the tris(alkylcyclopentadienyl)yttrium complex is a complex of the formula: 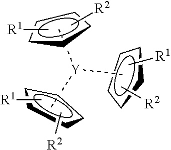
where:
R¹ and R² are each independently a hydrogen or an alkyl.

20. The method of claim 11, further comprising:
removing at least a portion of the non-coordinating solvent, so as to obtain the tris(alkylcyclopentadienyl)yttrium complex in a solid phase.
